(19) United States
(12) Patent Application Publication
(10) Pub. No.: US 2010/0176986 A1
(43) Pub. Date: Jul. 15, 2010

(54) APPARATUS AND METHOD FOR CALCULATING POSITION OF MOBILE TERMINAL

(75) Inventor: Do-young KWON, Suwon-si (KR)

Correspondence Address: H.C. PARK & ASSOCIATES, PLC, 8500 LEESBURG PIKE, SUITE 7500, VIENNA, VA, 22182, US

(73) Assignee: PANTECH&CURITEL COMMUNICATIONS, INC., Seoul (KR)

(21) Appl. No.: 12/546,403

(22) Filed: Aug. 24, 2009

(30) Foreign Application Priority Data
Jan. 13, 2009 (KR) 10-2009-0002665

(51) Int. Cl. G01S 5/14; G01S 1/00

(52) U.S. Cl. 342/357.1; 342/357.13; 342/357.12

(57) ABSTRACT

An apparatus that calculates a mobile terminal position includes storage, an updater to receive global positioning system (GPS) satellite signals, and a position calculation unit. The apparatus stores GPS reference information, which is updated if an information update event occurs. Then, if a position calculation event occurs, the apparatus receives synchronization signals from the GPS satellite signals and calculates the position of the mobile terminal using the synchronization signals and the stored GPS reference information. A method for calculating a position of a mobile terminal includes calculating a transmission time period of each GPS satellite signal using synchronization signals, calculating a distance between each GPS satellite and the mobile terminal, calculating positions of the GPS satellites using GPS reference information, and calculating the position of the mobile terminal using GPS satellite positions and distances between the GPS satellites and mobile terminal.

### CROSS-REFERENCE TO RELATED APPLICATION

This application claims priority from and the benefit of Korean Patent Application No. 10-2009-2665, filed on Jan. 13, 2009, which is hereby incorporated by reference for all purposes as if fully set forth herein.

### BACKGROUND OF THE INVENTION

1. Field of the Invention

The following description relates to technology for calculating a position of a mobile terminal, and more particularly, to an apparatus and method for calculating a position of a mobile terminal employing a stand-alone method.

2. Discussion of the Background

Methods for calculating a position of a mobile terminal may be classified as one of two types. One type is a stand-alone method in which a mobile terminal receives global positioning system (GPS) satellite signals and calculates its own position using differences between transmission times and reception times of the GPS satellite signals.

The other type is an assisted-GPS (A-GPS) method in which a mobile terminal receives assistance information, which may be GPS satellite information, through a network, combines the assistance information with a GPS satellite signal received by the mobile terminal, and determines its own position.

The stand-alone method is relatively slow compared to the A-GPS method because full GPS satellite signals are received from at least three GPS satellites before the mobile terminal can calculate its position. On the other hand, the A-GPS method is capable of determining the position more quickly, but is more complex because assistance information is received through a network.

### SUMMARY OF THE INVENTION

Exemplary embodiments of the present invention provide an apparatus to calculate a position of a mobile terminal by storing GPS reference information referenced for position calculation in advance of the position calculation event. Exemplary embodiments of the present invention also provide a method for calculating the position of a mobile terminal.

Additional aspects of the invention will be set forth in the description which follows, and in part will be apparent from the description, or may be learned by practice of the invention.

An exemplary embodiment of the present invention discloses an apparatus to calculate a position of a mobile terminal. The apparatus includes a storage to store global positioning system (GPS) reference information corresponding to at least three GPS satellites, an updater to receive GPS satellite signals from the at least three GPS satellites, and to update the GPS reference information if an information update event occurs, and a position calculation unit to detect synchronization signals of the GPS satellite signals, and to calculate a position of the mobile terminal using the synchronization signals and the GPS reference information stored in the storage if a position calculation event occurs.

An exemplary embodiment of the present invention also discloses a method for calculating a position of a mobile terminal. The method includes a transmission time acquisition step of obtaining, at the mobile terminal, transmission times of global positioning system (GPS) satellite signals received from at least three GPS satellites if a position calculation event occurs, the transmission times obtained from synchronization signals of the GPS satellite signals, a transmission time period calculation step of calculating transmission time periods of the GPS satellite signals, a distance calculation step of calculating distances between the at least three GPS satellites and the mobile terminal, a satellite position calculation step of calculating positions of the at least three GPS satellites using GPS reference information about the at least three GPS satellites stored in advance of the position calculation event, and a mobile terminal position calculation step of calculating a position of the mobile terminal using the distances between the at least three GPS satellites and the mobile terminal, and the positions of the at least three GPS satellites.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a block diagram of an apparatus to calculate a position of a mobile terminal according to an exemplary embodiment of the present invention.

FIG. 2 is a flowchart illustrating a method for calculating a position of a mobile terminal according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. Like reference numerals in the drawings denote like elements.

Before describing the exemplary embodiments, terms used throughout this specification will be defined. These terms are defined only in consideration of the exemplary embodiments and to further the understanding of these exemplary embodiments, however, and are not intended to limit the scope of invention.

The term “global positioning system (GPS) reference information” refers to information that is stored in a mobile terminal in advance and referenced for position calculation. GPS reference information is updated by an information update event occurring upon certain conditions, such as cell movement or the elapse of a predetermined time.

The term “information update event” refers to an event, such as cell movement or the elapse of a predetermined time. An information update event triggers a position calculating apparatus to receive GPS satellite signals from GPS satellites and to update GPS reference information with the GPS satellite signals.

The term “position calculation event” refers to an event that occurs due to certain conditions, such as a user input. A position calculation event triggers a position calculating apparatus to calculate a position of a mobile terminal using GPS reference information stored in advance of the position calculation event and minimal information of a received GPS satellite signal.

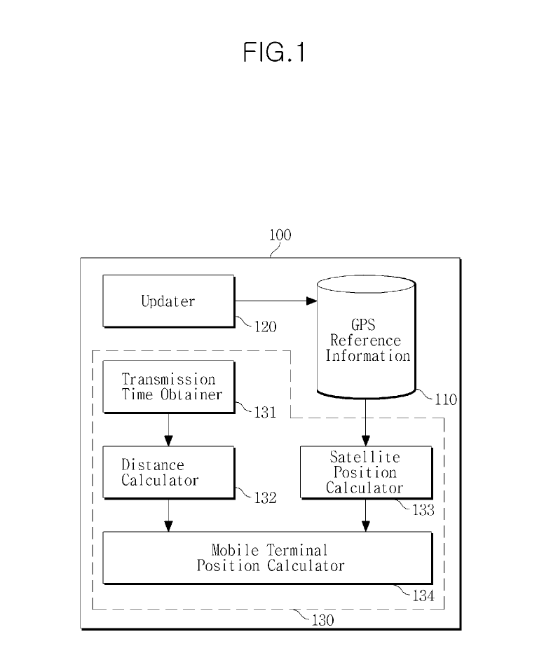

FIG. 1 is a block diagram of an apparatus to calculate a position of a mobile terminal according to an exemplary embodiment of the present invention. As shown in the drawing, an apparatus 100 to calculate a position of a mobile terminal includes a storage 110 to store GPS reference information, an updater 120, and a position calculation unit 130.

The storage 110 stores GPS reference information. The GPS reference information is referenced for position calculation and stored in a mobile terminal in advance of the position calculation event. For example, the GPS reference information may include orbit information of a GPS satellite, GPS satellite signal delay information, universal time coordinated (UTC) information, and approximate orbit information of all GPS satellites.

A GPS satellite signal transmitted from a GPS satellite includes information referenced for position calculation, such as orbit information of the GPS satellite recorded every hour, known as ephemeris data, information about delay of the GPS satellite signal caused by the ionosphere, etc., known as ionospheric (IONO) data, UTC information, and approximate orbit information of all GPS satellites, known as almanac data. Such information referenced for position calculation is stored in the storage 110 as GPS reference information before the position calculation event.

If the information update event occurs, the updater 120 receives GPS satellite signals from three GPS satellites and updates the GPS reference information. For example, the information update event may occur upon cell movement or the elapse of a predetermined time.

If the information update event occurs, that is, if a cell identification (ID) varies, if the predetermined time set for GPS reference information update elapses, etc., the updater 120 receives GPS satellite signals from the GPS satellites and updates the GPS reference information, thereby keeping the GPS reference information referenced for position calculation current.

If the position calculation event occurs, the position calculation unit 130 detects synchronization signals of the GPS satellite signals received from the GPS satellites, and calculates a position of the corresponding mobile terminal using the detected synchronization signals in conjunction with the GPS reference information about the GPS satellites stored in the storage 110.

Here, the position calculation event may occur due to a user input such as a key operation by a user. Meanwhile, the synchronization signals may include information about transmission times at which the GPS satellite signals are transmitted from the GPS satellites.

For example, the synchronization signals may be handover word data included in headers of the GPS satellite signals. The handover word data is synchronization information for transmission included in the GPS satellite signals, and includes the GPS satellite signal transmission time information. Additionally, because the synchronization signals may be received from the headers of the GPS satellite signals, the apparatus 100 does not need to receive the entire GPS satellite signals before calculating the position of the mobile terminal. Thus, the position calculation can occur more rapidly than in the conventional stand-alone method.

The position calculation unit 130 may include a transmission time obtainer 131, a distance calculator 132, a satellite position calculator 133, and a mobile terminal position calculator 134.

The transmission time obtainer 131 obtains transmission times of the GPS satellite signals received from the GPS satellites. Specifically, the transmission times are obtained from the synchronization signals of the GPS satellite signals. For example, the transmission time obtainer 131 can obtain GPS satellite signal transmission time information from handover word data included in the GPS satellite signals.

The distance calculator 132 calculates a transmission time period of each GPS satellite signal by subtracting the transmission time of the GPS satellite signal obtained by the transmission time obtainer 131 from reception time of the GPS satellite signal, and calculates a distance between each GPS satellite and the mobile terminal by multiplying the calculated transmission time period of each GPS satellite signal by a GPS satellite signal velocity.

For example, if a GPS satellite signal transmission time of a GPS satellite is t1, and a GPS satellite signal reception time of a mobile terminal is t2, a distance S between the GPS satellite and the mobile terminal equals c(t2−t1) according to the distance formula. Here, c denotes a GPS satellite signal velocity that is a known value (the speed of light), and (t2−t1) denotes a transmission time period of the GPS satellite signal.

The satellite position calculator 133 calculates a position of a GPS satellite using GPS reference information about the GPS satellite stored in the storage 110. Since the GPS reference information includes information referenced for position calculation, for example, orbit information of the GPS satellite, GPS satellite signal delay information, UTC information, and approximate orbit information of all the GPS satellites, the satellite position calculator 133 can calculate a position of the GPS satellite using the GPS reference information. An algorithm for calculating a position of a GPS satellite is known, and will not be described in detail.

The mobile terminal position calculator 134 calculates a position of the mobile terminal using the distances between the GPS satellites and the mobile terminal calculated by the distance calculator 132, and the positions of the GPS satellites calculated by the satellite position calculator 133.

A position of an object can be measured when distances between the object and at least three reference points having absolute coordinates are known. This is referred to as trilateration.

Since the distances between the GPS satellites and the mobile terminal are calculated by the distance calculator 132, and the positions of the GPS satellites are calculated by the satellite position calculator 133, the mobile terminal position calculator 134 can calculate the position of the mobile terminal using trilateration if it has these distances and positions for at least three GPS satellites.

If the mobile terminal position calculator 134 has these distances and positions for more than three GPS satellites, the apparatus 100 may determine a position of the mobile terminal in different ways. For example, a GPS satellite may be disregarded according to error calculations or according to other determinations, such as weaker signal strength of the disregarded GPS satellite signal. In another example, the satellite position calculator 133 may select the three GPS satellites that are most evenly spaced around the mobile terminal, or that are closest to the mobile terminal, for being used by the mobile terminal position calculator 134 to calculate the mobile terminal position. In another example, the mobile terminal position calculator 134 may calculate the mobile terminal position using two or more iterations of trilateration using a different combination of GPS satellites, and may determine the position of the mobile terminal as a position that is repeated after two or more iterations.

In this way, the apparatus 100 stores information, which is updated if the information update event occurs and referred to for position calculation, in a mobile terminal in advance of a position calculation event. Then, if the position calculation event occurs, the apparatus receives only minimal information of a GPS satellite signal, such as synchronization signals sent during the first two slots of the GPS satellite signal, such that the mobile terminal calculates its own position. Therefore, it is unnecessary to receive the whole GPS satellite signal to calculate the position of the mobile terminal, and the position of the mobile terminal can be more rapidly calculated using the stand-alone method.

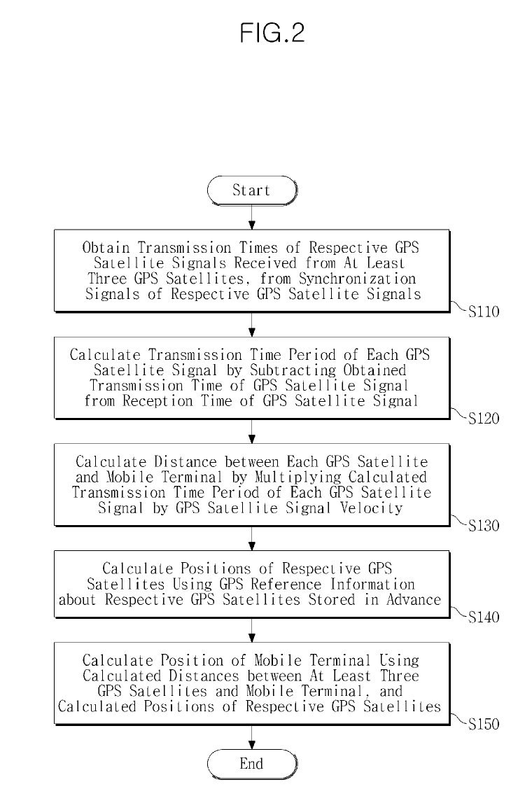

A position calculation operation of the apparatus having the above-described constitution according to an exemplary embodiment will be described with reference to FIG. 2. FIG. 2 is a flowchart illustrating a method for calculating a position of a mobile terminal according to an exemplary embodiment of the present invention.

If a position calculation event occurs, in a transmission time acquisition operation (S110), a mobile terminal obtains transmission times of GPS satellite signals received from three GPS satellites. The transmission times are obtained from synchronization signals of the respective GPS satellite signals.

Here, the position calculation event may occur due to a user input such as a key operation by a user. Meanwhile, the synchronization signals include information about transmission times at which the GPS satellite signals are transmitted from the GPS satellites.

For example, the synchronization signals may be handover word data included in headers of the GPS satellite signals. The handover word data is synchronization information for transmission included in the GPS satellite signals, and includes the GPS satellite signal transmission time information.

Then, in a transmission time period calculation operation (S120), the mobile terminal calculates a transmission time period of each GPS satellite signal by subtracting transmission time of the GPS satellite signal obtained in the transmission time acquisition operation (S110) from reception time of the GPS satellite signal.

Next, in a distance calculation operation (S130), the mobile terminal calculates a distance between each GPS satellite and the mobile terminal by multiplying the transmission time period of each GPS satellite signal calculated in the transmission time period calculation operation (S120) by a GPS satellite signal velocity.

For example, if a GPS satellite signal transmission time of a GPS satellite is t1, and a GPS satellite signal reception time of a mobile terminal is t2, a distance S between the GPS satellite and the mobile terminal equals c(t2−t1) according to the distance formula. Here, c denotes a GPS satellite signal velocity that is a known value (the speed of light), and (t2−t1) denotes a transmission time period of the GPS satellite signal.

Then, in a satellite position calculation operation (S140), the mobile terminal calculates a position of each GPS satellite using GPS reference information about the GPS satellite stored in advance of a position calculation event.

Here, the GPS reference information about each GPS satellite stored in advance of the position calculation event is referenced for position calculation and stored in the mobile terminal in advance. For example, the GPS reference information may include orbit information of the GPS satellite, GPS satellite signal delay information, UTC information, and approximate orbit information of all the GPS satellites.

A GPS satellite signal transmitted from a GPS satellite includes information referenced for position calculation, such as orbit information of the GPS satellite recorded every hour, known as ephemeris data, information about delay of the GPS satellite signal caused by the ionosphere, etc., known as IONO data, UTC information, and approximate orbit information of all GPS satellites, known as almanac data. Such information referenced for position calculation is stored in the mobile terminal as GPS reference information.

Meanwhile, if the information update event occurs, the GPS reference information about each GPS satellite stored in advance may be updated with information included in GPS satellite signals received from the GPS satellites. For example, the information update event may occur upon cell movement or the elapse of a predetermined time.

If the information update event occurs, that is, if a cell ID varies, if the predetermined time set for GPS reference information update elapses, etc., the mobile terminal receives a GPS satellite signal from each GPS satellite and updates the GPS reference information, thereby keeping the GPS reference information referenced for position calculation up to date.

In a mobile terminal position calculation operation (S150), the mobile terminal calculates its own position using the distances between the GPS satellites and the mobile terminal from the distance calculation operation (S130), and the positions of the GPS satellites calculated in the satellite position calculation operation (S140).

Since the distances between the GPS satellites and the mobile terminal are calculated in the distance calculation operation (S130) and the positions of the respective GPS satellites are calculated in the satellite position calculation operation (S140), the position of the mobile terminal can be calculated. Specifically, if the distances and positions are obtained for three or more GPS satellites, the position of the mobile terminal can be calculated using trilateration.

Thus, GPS reference information is updated if the information update event occurs in a mobile terminal in advance of a position calculation event. The GPS reference information is stored in the mobile terminal. Then, if the position calculation event occurs, only minimal information of a GPS satellite signal is received such that the mobile terminal calculates its own position. Therefore, the mobile terminal may not need to receive the entire GPS satellite signal in order to calculate its position, and the position of the mobile terminal can be more rapidly calculated than when using the conventional stand-alone method.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An apparatus to calculate a position of a mobile terminal, comprising:
a storage to store global positioning system (GPS) reference information corresponding to at least three GPS satellites;
an updater to receive GPS satellite signals from the at least three GPS satellites, and to update the GPS reference information if an information update event occurs; and
a position calculation unit to detect synchronization signals of the GPS satellite signals, and to calculate a position of the mobile terminal using the synchronization signals and the GPS reference information stored in the storage if a position calculation event occurs.

2. The apparatus of claim 1, wherein the position calculation unit comprises:
a transmission time obtainer to obtain transmission times of the GPS satellite signals from the synchronization signals of the GPS satellite signals;
a distance calculator to calculate transmission time periods of the GPS satellite signals, and to calculate distances between the at least three GPS satellites and the mobile terminal;
a satellite position calculator to calculate positions of the at least three GPS satellites using the GPS reference information stored in the storage; and
a mobile terminal position calculator to calculate the position of the mobile terminal using the distances between the at least three GPS satellites and the mobile terminal, and the positions of the at least three GPS satellites.

3. The apparatus of claim 2, wherein the GPS reference information includes:
orbit information of a GPS satellite;
GPS satellite signal delay information;
universal time coordinated (UTC) information; and
approximate orbit information of all of the GPS satellites.

4. The apparatus of claim 2, wherein the synchronization signals comprise handover word data included in headers of the GPS satellite signals.

5. The apparatus of claim 2, wherein a transmission time period of a GPS satellite signal is determined by subtracting a transmission time of the GPS satellite signal obtained by the transmission time obtainer from a reception time of the GPS satellite signal.

6. The apparatus of claim 2, wherein a distance between a GPS satellite and the mobile terminal is obtained by multiplying a transmission time period of a GPS satellite signal by a GPS satellite signal velocity.

7. The apparatus of claim 1, wherein the information update event occurs upon cell movement or elapse of a predetermined time.

8. The apparatus of claim 1, wherein the position calculation event occurs in response to a user input.

9. A method for calculating a position of a mobile terminal, comprising:
a transmission time acquisition step of obtaining, at the mobile terminal, transmission times of global positioning system (GPS) satellite signals received from at least three GPS satellites if a position calculation event occurs, the transmission times obtained from synchronization signals of the GPS satellite signals;
a transmission time period calculation step of calculating transmission time periods of the GPS satellite signals;
a distance calculation step of calculating distances between the at least three GPS satellites and the mobile terminal;
a satellite position calculation step of calculating positions of the at least three GPS satellites using GPS reference information about the at least three GPS satellites stored in advance of the position calculation event; and
a mobile terminal position calculation step of calculating a position of the mobile terminal using the distances between the at least three GPS satellites and the mobile terminal, and the positions of the at least three GPS satellites.

10. The method of claim 9, wherein the GPS reference information about the at least three GPS satellites is updated with information included in the GPS satellite signals if an information update event occurs.

11. The method of claim 10, wherein the information update event occurs upon cell movement or elapse of a predetermined time.

12. The method of claim 9, wherein the position calculation event occurs in response to a user input.

13. The method of claim 9, wherein calculating a transmission time period of a GPS satellite signal comprises subtracting a transmission time of the GPS satellite signal obtained in the transmission time acquisition step from a reception time of the GPS satellite signal.

14. The method of claim 9, wherein calculating a distance between a GPS satellite and the mobile terminal comprises multiplying a transmission time period of the GPS satellite signal calculated in the transmission time period calculation step by a GPS satellite signal velocity.
